(19) United States
(12) Patent Application Publication
(10) Pub. No.: US 2026/0208439 A1
(43) Pub. Date: Jul. 23, 2026

(54) HIGH-TEMPERATURE MAGNETIC FIELD-ASSISTED ADDITIVE MANUFACTURING (MFAAM) FOR CREATING SPECIALIZED BONDED MAGNETS WITH TAILORED MAGNETIC PROPERTIES

(71) Applicant: Texas State University, San Marcos, TX (US)

(72) Inventors: Jitendra S. Tate, Austin, TX (US); Mandesh Khadka, Dallas, TX (US); Pratik Uday Karkhanis, San Marcos, TX (US); Wilhelmus Geerts, Austin, TX (US)

(21) Appl. No.: 19/452,345

(22) Filed: Jan. 18, 2026

Related U.S. Application Data
(60) Provisional application No. 63/746,987, filed on Jan. 18, 2025.

(51) Int. Cl. B29C 64/194; B29C 64/118; B29K 71/00; B29K 77/00; B29K 105/16; B29K 505/12; B33Y 10/00; B33Y 30/00; B33Y 70/10; B33Y 80/00; H01F 41/02

(52) U.S. Cl. CPC B29C 64/194; B29C 64/118; B33Y 10/00; B33Y 30/00; B33Y 70/10; B33Y 80/00; H01F 41/0253; B29K 2071/00; B29K 2077/00; B29K 2105/16; B29K 2505/12; B29K 2995/0008

(57) ABSTRACT

A magnetic field-assisted additive manufacturing (MFAAM) system and method for fabricating anisotropic bonded magnets. The system includes a magnetic field source assembly including a modular Halbach holder, an inner Halbach holder, and a Halbach cylinder configured to provide a magnetic field for aligning magnetic fillers within a polymer matrix during extrusion. The field gradient of the Halbach cylinder is less than 0.0005 T/mm allowing to obtain high print quality in a large magnetic field. To enable high-temperature processing, the assembly incorporates a cooling casing fluidly coupled to a cooling medium. This active thermal management maintains the Halbach cylinder below a threshold temperature while a heated nozzle extrudes the composite material at temperatures sufficient to melt high-performance polymers. The integration of the magnetic source and cooling jacket allows for the precise alignment of magnetic domains in high-viscosity matrices, resulting in 3D-printed bonded magnets with consistent magnetic anisotropy and improved structural properties.

### TECHNICAL FIELD

The present disclosure relates generally to additive manufacturing, and more particularly to high-temperature magnetic field-assisted additive manufacturing (MFAAM) for creating specialized bonded magnets with tailored magnetic properties.

### BACKGROUND

Additive manufacturing, or 3D printing, has emerged as a transformative process for creating complex geometries that are often difficult or impossible to achieve through traditional manufacturing methods. In the field of magnetic materials, 3D printing offers the potential to produce bonded magnets with distinct pole patterns by using specialized filaments composed of a polymer matrix combined with magnetic filler materials. These filaments are typically extruded through a heated nozzle and deposited layer-by-layer to form a three-dimensional object.

To enhance the performance of 3D-printed magnets, it is often desirable to induce local magnetic anisotropy, where the magnetic properties vary depending on the direction and position. This is typically achieved by aligning magnetic particles that possess a magnetic anisotropy within the composite material in a specific direction while the material is in a molten or semi-molten state. This alignment takes place in-situ, by applying a magnetic field to the suspension of magnetic particles during the 3D printing process, referred to as Magnetic Field Assisted Additive Manufacturing (MFAAM), or after completion of the printing process by applying a magnetic field and raising the temperature of the printed object above the softening temperature. Two different types of magnetic field units are used to generate the magnetic fields for MFAAM, such as electromagnets and permanent magnets. To obtain good magnetic anisotropy, the applied field needs to exceed the coercivity field of the magnetic particles which is typically 0.4-0.6 Tesla for bonded magnets based on hexaferrites. Although both methods can generate the required magnetic fields to obtain good magnetic anisotropy, at higher applied fields the print material is deflected to the poles of the electromagnet or permanent magnet used in the field unit, and print quality is compromised resulting in rough surfaces and reduced print resolution.

MFAAM systems using permanent magnets face additional significant technical challenges, particularly when printing bonded magnets using high-temperature polymer matrices, such as PEEK or specific Nylon variants. During extended printing sessions, the high temperatures required to melt these composites can transfer heat from the printer's nozzle and heat block to the external magnets used to generate the print-field. Most permanent magnets, including high-strength Neodymium magnets, lose magnetic flux as their temperature increases, which can lead to permanent demagnetization. This degradation in magnetic strength directly compromises the system's ability to effectively align magnetic domains, resulting in poor magnetic anisotropy and overall reduced performance of the printed component.

Furthermore, standard MFAAM setups often lack the modularity required for integration across various desktop and industrial 3D printing platforms. There remains a critical need in the art for an MFAAM system that can reliably operate at high temperatures without compromising the strength of the external magnetic field, while remaining compatible with a wide array of additive manufacturing equipment.

### SUMMARY

In one embodiment of the present disclosure, a system for high-temperature magnetic field-assisted additive manufacturing (MFAAM) comprises an additive manufacturing device having a gantry system and a print head configured to extrude a composite filament comprising a polymer matrix and magnetic fillers. The system further comprises a magnetic field source mounted to the gantry system, where the magnetic field source comprises a Halbach cylinder configured to apply a uniform external magnetic field to the composite filament during extrusion. The system additionally comprises a cooling casing surrounding at least a portion of the Halbach cylinder, where the cooling casing is configured to maintain the Halbach cylinder below a threshold temperature to prevent demagnetization.

In one embodiment of the present disclosure, a method for fabricating an anisotropic bonded magnet using high-temperature magnetic field-assisted additive manufacturing (MFAAM) comprises feeding a composite filament into a 3D printer, where the composite filament comprises a polymer matrix and magnetic fillers. The method further comprises extruding the composite filament through a heated nozzle while applying a uniform external magnetic field via a Halbach cylinder to align the magnetic fillers in a specific direction. The method additionally comprises actively cooling the Halbach cylinder using a fluid-filled casing to prevent heat transfer from the heated nozzle from reducing magnetic flux of the Halbach cylinder, where the aligned magnetic fillers are locked within the polymer matrix upon cooling to form a 3D-printed bonded magnet having a predetermined magnetic anisotropy.

In one embodiment of the present disclosure, a modular magnetic alignment attachment for an additive manufacturing gantry system comprises a Halbach cylinder configured to generate a magnetic field of at least 0.3 T at a print location. The modular magnetic alignment attachment further comprises a hollow copper casing enclosing the Halbach cylinder, where the copper casing has fluid ports for connection to an external cooling system. The modular magnetic alignment attachment additionally comprises a mounting bracket configured for universal attachment to a 3D printer print head assembly.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a schematic view of the alignment of magnetic fillers using a transverse field during a high-temperature magnetic field-assisted additive manufacturing (MFAAM) process in accordance with an embodiment of the present disclosure;

FIG. 2 illustrates a schematic view of the alignment of magnetic fillers using a longitudinal print field during a high-temperature magnetic field-assisted additive manufacturing (MFAAM) process in accordance with an alternative embodiment of the present disclosure;

FIG. 3 illustrates an exploded perspective view of the magnetic field source assembly in accordance with an embodiment of the present disclosure;

FIG. 4 illustrates a detailed perspective and dimensioned view of the modular Halbach holder in accordance with an embodiment of the present disclosure;

FIG. 5 illustrates perspective views of the inner Halbach holder in accordance with an embodiment of the present disclosure;

FIG. 6 illustrates an embodiment of the holder bracket in accordance with an embodiment of the present disclosure;

FIG. 7 illustrates the cooling casing in isolation in accordance with an embodiment of the present disclosure;

FIG. 8 illustrates a perspective view of the additive manufacturing device integrated with a 3D printer in accordance with an embodiment of the present disclosure;

FIG. 9 illustrates an enlarged view of the print head assembly in operation in accordance with an embodiment of the present disclosure; and

FIG. 10 is a flowchart of a method for fabricating an anisotropic bonded magnet using high-temperature magnetic field-assisted additive manufacturing (MFAAM) in accordance with an embodiment of the present disclosure.

### DETAILED DESCRIPTION

As stated above, additive manufacturing, or 3D printing, has emerged as a transformative process for creating complex geometries that are often difficult or impossible to achieve through traditional manufacturing methods. In the field of magnetic materials, 3D printing offers the potential to produce bonded magnets with distinct pole patterns by using specialized filaments composed of a polymer matrix combined with magnetic filler materials. These filaments are typically extruded through a heated nozzle and deposited layer-by-layer to form a three-dimensional object.

To enhance the performance of 3D-printed magnets, it is often desirable to induce local magnetic anisotropy, where the magnetic properties vary depending on the direction and position. This is typically achieved by aligning magnetic particles that possess a magnetic anisotropy within the composite material in a specific direction while the material is in a molten or semi-molten state. This alignment takes place in-situ, by applying a magnetic field to the suspension of magnetic particles during the 3D printing process, referred to as Magnetic Field Assisted Additive Manufacturing (MFAAM), or after completion of the printing process by applying a magnetic field and raising the temperature of the printed object above the softening temperature. Two different types of magnetic field units are used to generate the magnetic fields for MFAAM, such as electromagnets and permanent magnets. To obtain good magnetic anisotropy, the applied field needs to exceed the coercivity field of the magnetic particles which is typically 0.4-0.6 Tesla for bonded magnets based on hexaferrites. Although both methods can generate the required magnetic fields to obtain good magnetic anisotropy, at higher applied fields the print material is deflected to the poles of the electromagnet or permanent magnet used in the field unit, and print quality is compromised resulting in rough surfaces and reduced print resolution.

MFAAM systems using permanent magnets face additional significant technical challenges, particularly when printing bonded magnets using high-temperature polymer matrices, such as PEEK or specific Nylon variants. During extended printing sessions, the high temperatures required to melt these composites can transfer heat from the printer's nozzle and heat block to the external magnets used to generate the print-field. Most permanent magnets, including high-strength Neodymium magnets, lose magnetic flux as their temperature increases, which can lead to permanent demagnetization. This degradation in magnetic strength directly compromises the system's ability to effectively align magnetic domains, resulting in poor magnetic anisotropy and overall reduced performance of the printed component.

Furthermore, standard MFAAM setups often lack the modularity required for integration across various desktop and industrial 3D printing platforms. There remains a critical need in the art for an MFAAM system that can reliably operate at high temperatures without compromising the strength of the external magnetic field, while remaining compatible with a wide array of additive manufacturing equipment.

The embodiments of the present disclosure provide a means for an MFAAM system that can reliably operate at high temperatures without compromising the strength and uniformity of the external magnetic field, while remaining compatible with a wide array of additive manufacturing equipment. In one embodiment, this is achieved through a specialized modular attachment featuring a high-strength homogeneous magnetic field source, such as a k=2 Neodymium Halbach cylinder, coupled with an active fluid-based cooling mechanism. By enclosing the magnetic Halbach cylinder in a cooling casing, such as a water-cooled copper jacket, the system effectively isolates the magnets from the intense heat generated by the print head's nozzle and heat block.

This technical configuration addresses two critical failure points in conventional MFAAM setups: (1) the distortion of the print process by the large field gradients caused by the magnetic poles of a conventional permanent magnetic field source; and (2) the thermal demagnetization of permanent magnets when processing high-temperature engineering polymers, such as PEEK or Nylon 4.6. The cooling casing is designed for continuous circular water flow, maintained by an external chiller and pump, ensuring the magnets remain below their critical threshold temperature (e.g., 70° C.) even as extrusion temperatures exceed 300° C. The use of a Halbach cylinder provides a concentrated, uniform magnetic field of approximately 0.3 T at the print location and 0.5 T at the extrusion nozzle, which enables the precise alignment of magnetic filler particles, such as strontium ferrite, without compromising the print quality in terms of surface roughness and print resolution.

Furthermore, the system is designed with a modular architecture that includes universal mounting brackets and a specialized Halbach holder. This allows the MFAAM setup to be integrated into a variety of desktop and industrial 3D printing gantries, transforming standard printers into high-performance tools for creating anisotropic bonded magnets with unique flux patterns. By manipulating the orientation of the Halbach cylinder with respect to the print direction, the print field can be kept transverse or longitudinal to the filament. A transverse print-field will induce a local magnetic anisotropy that has its easy axis parallel to the print bed. A longitudinal print field will induce a local magnetic anisotropy that has its easy axis oblique to the print bed where the angle the easy axis makes with the print bed normal depends on print parameters including print speed, strength of the print field, nozzle diameter, layer height, and nozzle, enclosure, and bed temperatures. The resulting 3D-printed components exhibit superior magnetic properties, characterized by high S-values (Mᵣ/Mₛ) and distinct flux and pole patterns, making them ideal for specialized applications in aerospace, automotive powertrains, and medical devices.

In one embodiment, a composite filament with tailored magnetic filler weight percentages is fed into the system and extruded through a heated nozzle that is centered in the cooled magnetic Halbach cylinder. The uniform field of the Halbach cylinder parallel to the print bed limits horizontal forces acting on the moltens suspension during the printing process avoiding loss of print quality at large print fields. The active cooling prevents the loss of magnetic flux during long duration prints, ensuring consistent alignment of the magnetic domains throughout the entire geometry of the part. This capability to maintain high-field integrity during high-temperature processing allows for the manufacturing of complex, lightweight, and high-efficiency magnetic sensors, actuators, and motors that were previously unachievable with standard additive manufacturing techniques.

A further discussion regarding these and other features is provided below.

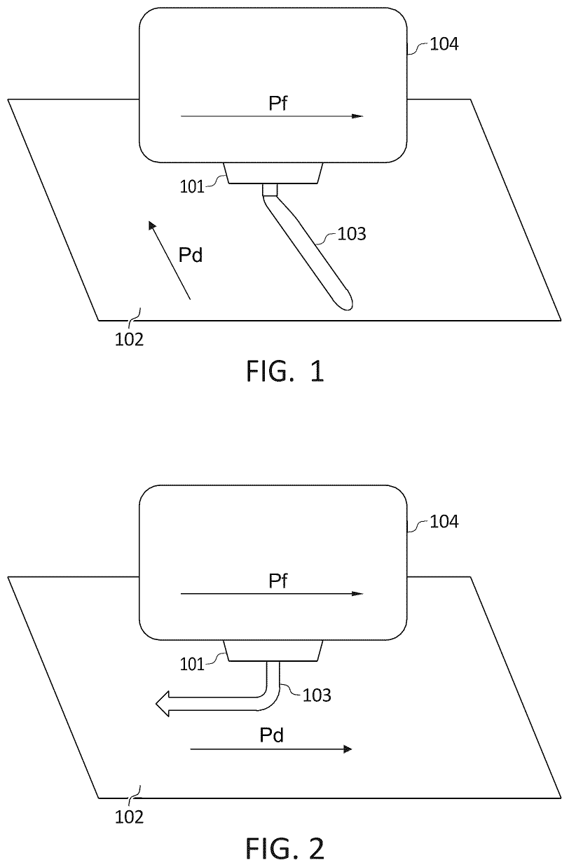

Referring now to the Figures in detail, FIG. 1 illustrates a schematic view of the alignment of magnetic fillers using a transverse field during a high-temperature magnetic field-assisted additive manufacturing (MFAAM) process in accordance with an embodiment of the present disclosure. As shown in FIG. 1, a composite material is extruded through a brass nozzle 101 (e.g., diameter of. 0.4 mm) to be deposited onto a print bed 102. In one embodiment, brass nozzle 101 extrudes the material in a specific print direction (Pd), represented by a horizontal vector, to form a printed magnetic composite 103 on the surface of print bed 102.

To induce the desired magnetic properties within the structure, a print magnetic field (Pf) 104 is applied to the material at the point of extrusion. In the embodiment illustrated in FIG. 1, print magnetic field (Pf) 104 is oriented as a horizontal vector that is perpendicular to the horizontal print direction (Pd) of the print head. As printed magnetic composite 103 is laid down, the magnetic particles within the molten matrix align with print magnetic field (Pf) 104. This alignment is preserved as the polymer matrix solidifies, resulting in printed magnetic composite 103 characterized by a local easy axis parallel to print bed 102 perpendicular to the print direction.

Referring now to FIG. 2, FIG. 2 illustrates a schematic view of the alignment of magnetic fillers using a longitudinal print field during a high-temperature magnetic field-assisted additive manufacturing (MFAAM) process in accordance with an alternative embodiment of the present disclosure. In this embodiment, the system is configured to induce a local oblique easy axis that is tilted with respect to print bed 102.

Similar to the embodiment shown in FIG. 1, a composite material is extruded through brass nozzle 101 and deposited onto print bed 102. Brass nozzle 101 translates in a specific print direction (Pd), represented by a horizontal vector, to form printed magnetic composite 103.

To induce a different magnetic orientation within the structure, print magnetic field (Pf) 104 is applied such that the magnetic flux lines are substantially aligned with the extrusion path. Specifically, as illustrated in FIG. 2, print magnetic field (Pf) 104 is oriented as a horizontal vector that is parallel to the print direction (Pd) of the print head.

In one embodiment, the magnetic particles in the nozzle are aligned parallel the print field Pf which is parallel to the print direction Pd. Once the extruded composite 103 folds over on print bed 102, the orientation of the particles quickly changes to a direction perpendicular to print bed 102 and the print field Pf exerts a torque on the magnetic particles rotating them again towards the longitudinal print field Pf 104. This orientation of the particles is fixed as the polymer matrix (e.g., PEEK or Nylon 4.6) solidifies on print bed 102, resulting in printed magnetic composite 103 with an oblique easy axis. The local easy anisotropy axis lays in a plane defined by the normal vector of print bed 102 and the print-field direction. The tilt angle of the local easy axis can be changed by changing the quenching rate, which mainly depends on print parameters, such as layer height, print speed, nozzle diameter, strength of the print-field, and nozzle, bed, and enclosure temperatures. For high quenching rates, the angle between the local easy axis and the print bed normal will be small. The angle can be increased by lowering the quenching rate, such as lowering the print speed, providing more time for the magnetic particles to rotate parallel to the longitudinal print-field. By selecting between the transverse print-field configuration of FIG. 1 and the longitudinal print-field orientation of FIG. 2, the system provides a specialized means for obtaining any local anisotropy easy axis direction, tailoring the magnetic performance of the bonded magnet for specific applications, such as in electric vehicle powertrains or sensors.

As illustrated in FIGS. 1 and 2, the MFAAM system of the present disclosure induces a magnetic anisotropy easy axis in a printed samples using a substantial magnetic field, such as 0.5 Tesla in the extrusion nozzle and 0.3 Tesla at the actual location of the printing process, applied to extruded materials comprising magnetic particles, such as ferrite powder within a nylon matrix. The degree of alignment is represented by an S-value (Mᵣ/Mₛ), where a value of 1 indicates perfect alignment of magnetic particles. Mᵣ, as used herein, refers to remanent magnetization and Mₛ, as used herein, refers to saturation magnetization. Experimental results on samples printed in a transverse field confirm that the S is maximum to the print direction confirming the existence of an easy magnetic anisotropy axis induced in the material. Typical peak S-values are 0.965 for 10 wt. % and 0.94 for 35 wt. % and 0.92 for 54 wt. % SrFe₁₂O₁₉/Nylon12. This verifies that alignment is established at the print nozzle during extrusion. For a longitudinal print field (FIG. 2), the largest S values are measured along the direction of the print bed normal which indicates that under these print parameters (Tbed=135° C., Tnozzle=255° C., vprint=20 mm/sec) solidification of the extrudate is rapid with little rotation of the particles after they are quenched on print bed 102. Typical peak S-values are 0.85 for 10 wt. % and 0.78 for 35 wt. % and 0.64 for 54 wt. % SrFe₁₂O₁₉/Nylon12.

In one embodiment, the MFAAM system of the present disclosure allows for customizing the magnetic strength of the printed bonded magnet by varying a weight percentage of the magnetic fillers. In one embodiment, the magnetic fillers (e.g., strontium ferrite powder) are varied between 10 wt. % to 54 wt. % to achieve desired magnetic properties.

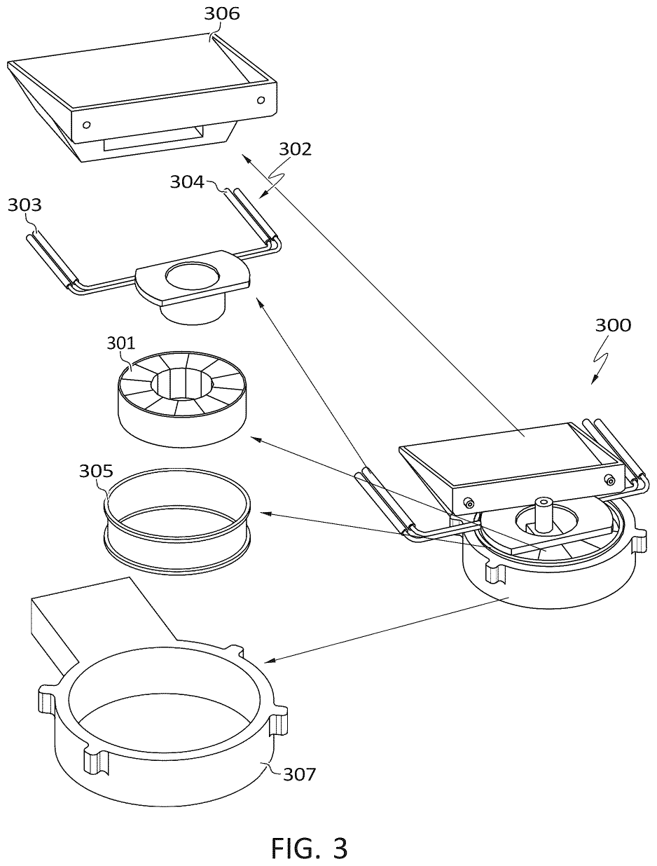

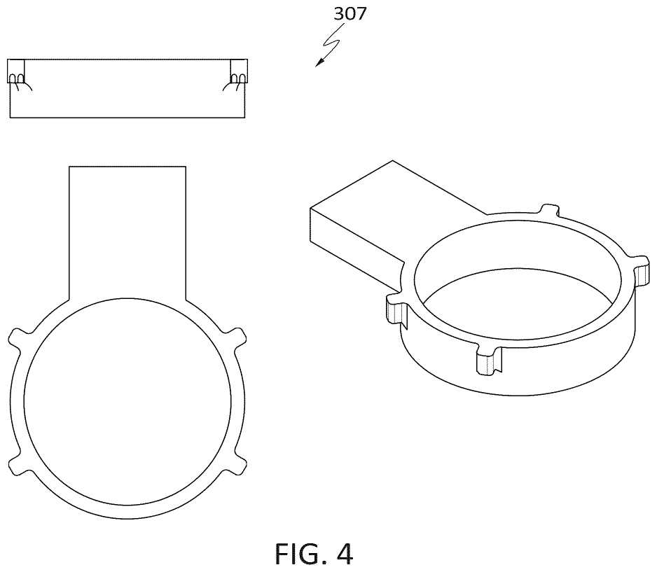

Referring now to FIG. 3, FIG. 3 illustrates an exploded perspective view of the magnetic field source assembly 300 in accordance with an embodiment of the present disclosure. In one embodiment, magnetic filed source assembly 300 is comprised of five primary interlocking components designed to facilitate magnetic alignment with minimal print quality loss while providing active thermal management.

Referring to the performance of the MFAAM setup, the system is configured to induce significant magnetic anisotropy in printed composite samples. In one embodiment, magnetic field source assembly 300 generates a magnetic field of approximately 0.5 Tesla at the extrusion point. The effectiveness of this field is quantified by the large S-value (Mᵣ/Mₛ), which represents the ratio of magnetic remanence to magnetic saturation.

Experimental calibration using the strontium ferrite (SrFe₁₂O₁₉) filler in a Nylon12 (PA12) matrix demonstrates the successful induction of anisotropy. Specifically, for a composite with 10 wt. % filler, the system achieves a peak S-value of 0.965 when the print field is applied perpendicular to the print direction (FIG. 1). For a higher loading of 54 wt. % filler, the system achieves an S-value of 0.92. These results confirm that the alignment of magnetic fillers is established precisely as the material exits the nozzle and is deposited.

In accordance with an embodiment of the present disclosure, the magnetic fillers include strontium ferrite powder. As demonstrated by experimental results, the use of strontium ferrite powder (SrFe₁₂O₁₉) within a polymer matrix, such as Nylon 12, allows for significant induction of anisotropy when processed through the MFAAM system. For example, a composite containing 10 wt. % of the strontium ferrite powder achieved a peak S-value of 0. 0.965, confirming high levels of alignment.

Furthermore, as illustrated in FIG. 3, magnetic field source assembly 300 includes several interlocking components designed for high-temperature service. The Neodymium Halbach cylinder (also referred to herein as simply “Halbach cylinder”) 301 is housed within an inner Halbach holder 305, which is further seated inside a modular Halbach holder 307. This assembly is secured to the 3D printer's motion system via a holder bracket 306.

In one embodiment, at the top of the assembly 300 is a holder bracket (also referred to as “mounting bracket”) 306, which is configured to secure the entire apparatus to a 3D printer gantry system. Positioned immediately below holder bracket 306 is a cooling casing 302, specifically a copper jacket designed for high thermal conductivity. In one embodiment, cooling casing 302 surrounds at least a portion of Halbach cylinder 301. In one embodiment, cooling casing 302 includes a fluid inlet 303 and a fluid outlet 304 (collectively referred to as fluid ports) through which a cooling medium is circulated. This configuration ensures that heat generated by the extrusion process is intercepted before reaching the temperature-sensitive magnetic components.

In one embodiment, the core of assembly 300 includes a Halbach cylinder 301, which consists of a plurality of permanent magnet segments, such as Neodymium-Iron-Boron (NdFeB) magnets or Samarium-Cobalt (SmCo) magnets configured for high-temperature service without active cooling. In one embodiment, Halbach cylinder 301 is a Halbach cylinder providing a horizontal magnetic field to a nozzle (e.g., nozzle 101) of the print head. In one embodiment, Halbach cylinder 301 is housed within a modular Halbach holder 307, which serves as the main structural body for the magnetic source. To ensure precise positioning and stability of the magnet segments, an inner Halbach holder 305 is provided, which seats into the modular Halbach holder 307 and secures Halbach cylinder 301 in a fixed orientation.

When assembled, these components form a central aperture through which the printer's extrusion nozzle passes. By circulating fluid through cooling casing 302, Halbach cylinder 301 is maintained below a threshold temperature, typically 70° C., even when the adjacent nozzle is extruding high-temperature polymers at temperatures exceeding 300° C. This integrated hardware stack allows for the continuous and reliable production of 3D-printed bonded magnets with consistent magnetic anisotropy.

In one embodiment, a second Halbach cylinder is inserted in a first Halbach cylinder (e.g., Halbach cylinder 301), where the first and second Halbach cylinders are rotated independently with respect to a printer.

Referring now to FIG. 4, FIG. 4 illustrates a detailed perspective and dimensioned view of modular Halbach holder 307 in accordance with an embodiment of the present disclosure. In one embodiment, modular Halbach holder 307 serves as the main structural body for the magnetic assembly and is configured to be mounted to a gantry system. As shown in the dimensioned views, modular Halbach holder 307 features a substantially circular primary housing with integrated mounting tabs for securing internal components.

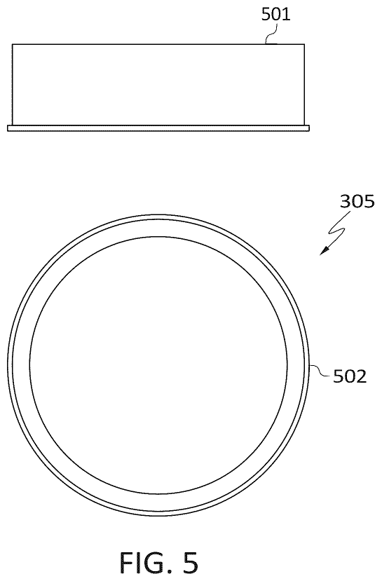

Referring now to FIG. 5, FIG. 5 illustrates perspective views of inner Halbach holder 305 in accordance with an embodiment of the present disclosure. As shown in the top and side perspective views 501, 502, inner Halbach holder 305 is specifically dimensioned to seat within modular Halbach holder 307. Inner Halbach holder 305 serves as the immediate housing for the magnet segments, ensuring they remain in a fixed orientation to maintain a consistent magnetic field.

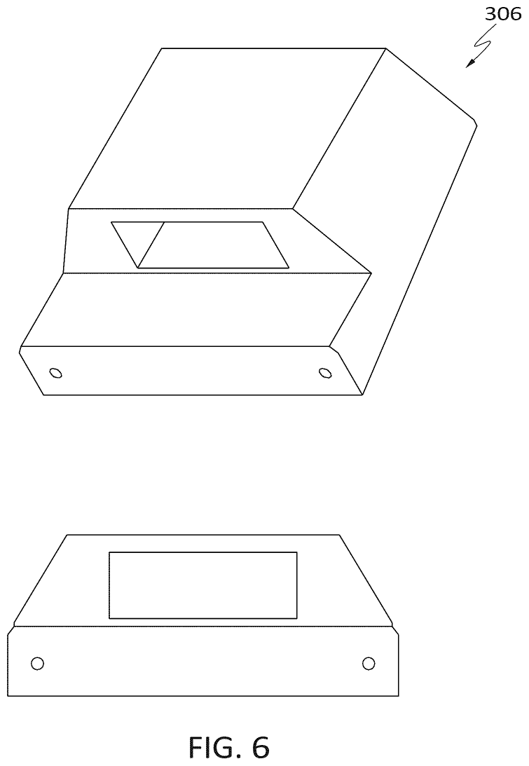

Referring now to FIG. 6, FIG. 6 illustrates an embodiment of holder bracket 306 (also referred to as the mounting bracket) in accordance with an embodiment of the present disclosure. In one embodiment, holder bracket 306 provides the structural interface between the printer's gantry system and the magnetic field source assembly. In one embodiment, holder bracket 306 is designed with a specific geometry to allow the printer's extrusion assembly to pass through its central opening while maintaining a rigid connection to the motion system.

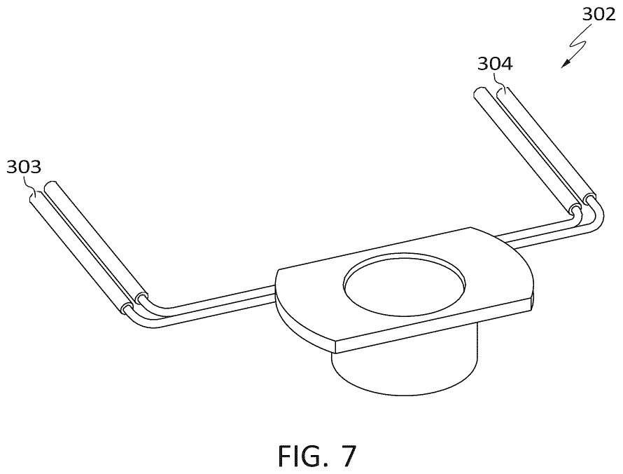

Referring now to FIG. 7, FIG. 7 illustrates cooling casing 302 in isolation in accordance with an embodiment of the present disclosure. In accordance with one embodiment, cooling casing 302 is a copper casing designed for active fluid cooling. In one embodiment, cooling casing 302 is hollow to allow cooling fluid to run circularly inside the unit. As shown, cooling casing 302 features two fluid inlets 303 and two fluid outlets 304, which are configured for connection to an external water pump and chiller. In one embodiment, such an active cooling mechanism prevents the Halbach cylinder (e.g., Halbach cylinder 301) from reaching temperatures (e.g., exceeding 70° C.) that lead to permanent demagnetization during high-temperature polymer extrusion where nozzle temperatures may exceed 300° C.

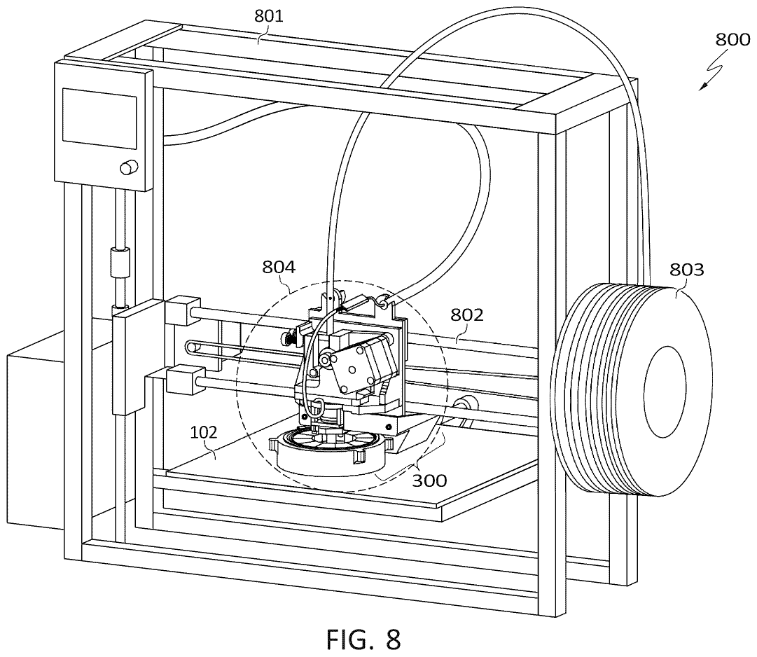

Referring now to FIG. 8, in conjunction with FIGS. 1-3, FIG. 8 illustrates a perspective view of the additive manufacturing device (also referred to as the “3D printer”) 800 integrated with a 3D printer 804 in accordance with an embodiment of the present disclosure. In one embodiment, magnetic field source assembly 300 is mounted to the gantry system 802 of the printer frame 801. In one embodiment, a filament source 803 provides the magnetic composite material, which is routed to the print head 804 (also referred to as the print head assembly) positioned within magnetic field source assembly 300. In one embodiment, print head 804 is configured to extrude a composite filament including a polymer matrix and magnetic fillers. A composite filament, as used herein, is a high-temperature additive manufacturing feedstock including a high-performance polymer matrix (e.g., Nylon, PEEK) integrated with a predetermined weight percentage of magnetic filler particles (e.g., strontium ferrite powder) that are capable of being aligned by an external magnetic field while the matrix is in a molten state. As gantry system 802 moves, the material is extruded onto print bed 102 to form a 3D-printed bonded magnet with specific magnetic anisotropy induced by the internal Halbach cylinder 301. In one embodiment, a magnetic field source is mounted to gantry system 802, where the magnetic field source corresponds to Halbach cylinder 301 of magnetic field source assembly 300 configured to apply a uniform external magnetic field to the composite filament during extrusion.

In one embodiment, additive manufacturing device 800 includes a modular Halbach holder 307 and a holder bracket 306 configured to secure magnetic field source assembly 300 to a plurality of different desktop 3D printer gantry systems. The design of the holder bracket 306 is modular, allowing the magnetic field source to be easily adapted and mounted to various gantry configurations found in commercial 3D printers. By utilizing this modular Halbach holder 307 and holder bracket 306, the system can be integrated as an aftermarket attachment or a primary component across a plurality of different desktop 3D printer gantry systems, thereby extending high-temperature MFAAM capabilities to existing printer hardware.

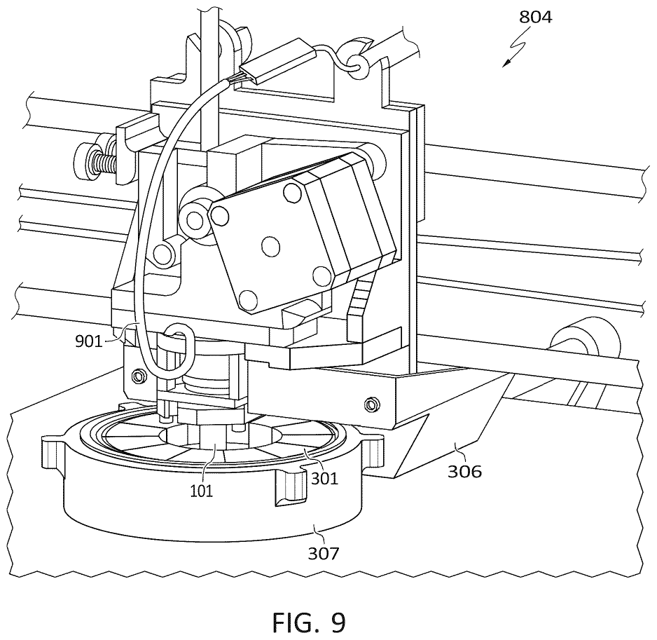

Referring now to FIG. 9, in conjunction with FIGS. 1-3 and 7, FIG. 9 illustrates an enlarged view of the print head assembly 804 in operation in accordance with an embodiment of the present disclosure. As illustrated in FIG. 9, modular Halbach holder 307 and holder bracket 306 are positioned in close proximity to the extrusion point. This detailed view confirms that the central aperture of the magnetic assembly is aligned with brass nozzle 101, allowing print magnetic field (Pf) 104 to act on the composite material precisely as it is deposited onto print bed 102.

The integration shown in FIG. 9 specifically highlights the active thermal management system in an operational state. Cooling casing 302 (detailed in FIG. 7) is seated internally within modular Halbach holder 307 and is fluidly coupled to external cooling lines, represented by tubing 901 entering the top of pint head assembly 804. These lines facilitate the circular flow of coolant through the hollow interior of cooling casing 302. In one embodiment, such a configuration is positioned to intercept heat from the printer's heat block and nozzle, thereby protecting internal Halbach cylinder 301 from reaching temperatures (e.g., above 70° C.) that would lead to permanent demagnetization.

In one embodiment, print head 804 is configured to extrude a composite filament including a polymer matrix and magnetic fillers. As shown in FIG. 9, print head 804 is integrated with magnetic field source assembly 300, ensuring that the magnetic field is applied directly at the point of extrusion.

Referring collectively to FIGS. 3-9, embodiments of the present disclosure provide a modular magnetic alignment attachment designed to be secured to print head 804 and gantry system 802. The modular magnetic alignment attachment includes a Halbach cylinder 301 configured to generate a magnetic field of at least 0.3 T at the print location. As shown in FIG. 7, a hollow copper casing 302 encloses Halbach cylinder 301 and includes fluid ports 303, 304 for connection to an external cooling system. Furthermore, as shown in FIG. 6, mounting bracket 306 is provided for universal attachment of the modular assembly to print head 804.

In one embodiment, Halbach cylinder 301 consists of a plurality of permanent magnet segments, such as Neodymium-Iron-Boron (NdFeB) magnets or Samarium-Cobalt (SmCo) magnets configured for high-temperature service without active cooling. In one embodiment, because Samarium-Cobalt (SmCo) magnets possess a significantly higher Curie temperature and higher resistance to thermal demagnetization compared to Neodymium magnets, they may be utilized in the modular magnetic alignment attachment in applications where the hollow copper casing 302 is not connected to a cooling medium, or where the ambient temperature of the print chamber exceeds the safe operating range of standard permanent magnets.

In one embodiment, during extended high-temperature printing, copper cooling casing 302 prevents Halbach cylinder 301 from reaching a service temperature where it would lose magnetic flux or suffer permanent demagnetization, typically above 70° C. In one embodiment, cooling casing 302 is hollow to allow a cooling medium, such as water, to run circularly inside via two fluid inlets 303 and two fluid outlets 304 connected to an external pump and chiller. This allows the system to process high-temperature composites with matrices, such as Polyether Ether Ketone (PEEK) and Nylon 4.6, where nozzle temperatures can be significantly higher.

One advantage of the embodiments of the present disclosure is its ability to operate at high temperatures required for engineering-grade polymers. Conventional MFAAM systems are often limited to low-temperature polymers because the heat from the nozzle can degrade the external magnets. In the embodiments of the present disclosure, cooling casing 302 enables the use of high-temperature matrices, such as Nylon 4.6 (PA46) and Polyether Ether Ketone (PEEK), which require nozzle temperatures exceeding 300° C.

By circulating coolant through cooling casing 302, Halbach cylinder 301 is maintained below a critical service temperature of 70° C. This thermal isolation is essential because Neodymium magnets (NdFeB) lose significant magnetic flux and may suffer permanent demagnetization if allowed to overheat. The active cooling ensures that the 0.5 Tesla alignment field remains stable throughout the duration of a high-temperature print, allowing for the consistent production of anisotropic bonded magnets with high structural integrity.

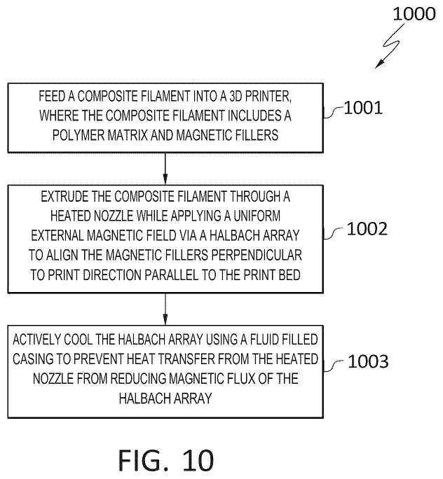

Referring now to FIG. 10, FIG. 10 is a flowchart of a method 1000 for fabricating an anisotropic bonded magnet using high-temperature magnetic field-assisted additive manufacturing (MFAAM) in accordance with an embodiment of the present disclosure. As discussed below, method 1000 utilizes the integrated hardware stack described in FIGS. 3-9 to achieve precise particle alignment in high-viscosity polymer matrices.

Referring to FIG. 10, in conjunction with FIGS. 1-9, in step 1001, a composite filament is fed into a 3D printer (e.g., 3D printer 800). In one embodiment, the composite filament includes a polymer matrix and magnetic fillers. In one embodiment, the polymer matrix may include high-temperature thermoplastics, such as Nylon 6, Nylon 66, Nylon 11, Nylon 12, Nylon 4.6 (PA46), Acrylonitrile Butadiene Styrene. (ABS) or Polyetheretherketone (PEEK). In one embodiment, the magnetic fillers may consist of hard magnetic materials, such as strontium ferrite (SrFe₁₂O₁₉) or Neodymium-Iron-Boron (NdFeB).

In step 1002, the composite filament is extruded through a heated nozzle while simultaneously applying a uniform external magnetic field via a Halbach cylinder 301 to align the magnetic fillers perpendicular to the print direction, parallel to print bed 102. In one embodiment, the extrusion is performed at a temperature sufficient to melt the polymer matrix, which can exceed 300° C. depending on the material selected. As the molten material exits brass nozzle 101, it passes through the center of magnetic field source assembly 300. In one embodiment, Halbach cylinder 301 then generates a concentrated magnetic field, such as a transverse field (FIG. 1) or a longitudinal field (FIG. 2), ranging from 0.5 T in the nozzle to 0.3 T at the print location. This field forces the magnetic fillers within the molten matrix to align with their easy axes with the magnetic flux lines before the material solidifies on print bed 102.

In one embodiment, the applied external magnetic filed induces a magnetic S-value of at least 0.965 in a direction normal to the print field (e.g., print bed 102) of the 3D printer (e.g., 3D printer 800). In one embodiment, Halbach cylinder 301 provides a substantially uniform magnetic field having a field gradient of less than 0.0005 T/mm within a central bore of the magnetic field source assembly 300.

In step 1003, Halbach cylinder 301 is actively cooled using a fluid-filled casing (e.g., cooling casing 302) to prevent heat transfer from the heated nozzle from reducing the magnetic flux of Halbach cylinder 301 during the extrusion process (i.e., to maintain the temperature of Halbach cylinder 301 below a threshold level (e.g., 70° C.) during the extrusion process). While the nozzle and heat block may operate at temperatures exceeding 300° C., the active cooling via cooling casing 302 ensures the Halbach cylinder 301 stays below approximately 70° C. This is achieved by circulating a cooling medium, such as water, through fluid inlet 303 and fluid outlet 304 using a pump and chiller system. This active thermal management prevents the permanent demagnetization of the magnets and ensures consistent magnetic anisotropy in the final printed part.

In one embodiment, Halbach cylinder 301 is rotated along its cylindrical axis by a stepmotor that is controlled through a G-code of 3D printer 800.

In one embodiment, method 1000 for fabricating the anisotropic bonded magnet results in the magnetic fillers being permanently aligned according to the magnetic field lines of Halbach cylinder 301. As the composite material is deposited and cools below the glass transition or melting temperature of the polymer matrix, the alignment is locked in place, resulting in a 3D-printed bonded magnet with a consistent and measurable magnetic anisotropy throughout its geometry. That is, the aligned magnetic fillers are locked within the polymer matrix upon cooling to form a 3D-printed bonded magnet having a predetermined magnetic anisotropy.

In this manner, the integration of the actively cooled magnetic field source assembly with a high-temperature extrusion system results in a synergistic improvement over prior systems. The setup not only allows for the processing of high-performance thermoplastics but also ensures that the magnetic alignment mechanism is not compromised by the necessary thermal energy of the printer and that the resolution of the 3D printing process is not compromised by large forces originating from magnetic field gradients of the magnetic field source. As evidenced by the calibrated S-values exceeding 0.965, the system effectively yields 3D-printed magnets with large magnetic anisotropy, suitable for high-performance applications in the automotive, aerospace, and robotics sectors.

Furthermore, in this manner, the present disclosure provides a significant improvement over conventional magnetic 3D printing by enabling the use of high-viscosity, high-temperature polymer matrices, such as PEEK and Nylon 4.6, which were previously incompatible with permanent magnet alignment systems. By integrating a copper cooling casing 302 directly into magnetic field source assembly 300, the present disclosure maintains Halbach cylinder 301 below its critical thermal threshold (e.g., 70° C.) while the adjacent nozzle 101 operates at temperatures exceeding 300° C. This active thermal management prevents permanent demagnetization of the magnetic segments, ensuring that a consistent and powerful alignment field is maintained throughout the entire printing process. Consequently, embodiments of the present disclosure allow for the reliable fabrication of anisotropic bonded magnets with superior magnetic properties and structural integrity compared to those produced via standard cold-printing or non-assisted methods.

Furthermore, the MFAAM system of the present disclosure enables precise control over the magnetic properties of the printed objects. During the 3D printing process, a strong magnetic field, such as generated by a Neodymium Halbach cylinder, is applied to the printing material. This magnetic field influences the orientation of magnetic particles within the material as it is being printed.

With the MFAAM system of the present disclosure, the magnetic force originating from the field gradients of the field source are limited to the direction perpendicular to the print bed so will not negatively impact the print quality. This precise control over the local orientation of the magnetic anisotropic particles allows for the creation of 3D-printed magnets and magnetic circuits with tailored properties. These properties include significantly increased magnetic strength by aligning all magnetic particles in the same direction, or distinct magnetic pole distributions in 3D printed magnetic objects. Furthermore, these properties include anisotropic properties, referring to the magnetic properties of the material being varied depending on the direction, which is important for many applications requiring fine-tuned magnetic behavior. Additionally, these properties include the ability to create intricate and complex magnetic shapes that would be difficult or impossible to achieve with traditional manufacturing methods.

Furthermore, the MFAAM system of the present disclosure incorporates high-temperature capabilities. This allows for the use of a wider range of materials, including high-temperature polymers and ceramics, which can withstand demanding operating conditions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for high-temperature magnetic field-assisted additive manufacturing (MFAAM), comprising:
an additive manufacturing device having a gantry system and a print head configured to extrude a composite filament comprising a polymer matrix and magnetic fillers;
a magnetic field source mounted to said gantry system, wherein said magnetic field source comprises a Halbach cylinder configured to apply a uniform external magnetic field to said composite filament during extrusion; and
a cooling casing surrounding at least a portion of said Halbach cylinder, wherein said cooling casing is configured to maintain said Halbach cylinder below a threshold temperature to prevent demagnetization.

2. The system as recited in claim 1, wherein said cooling casing comprises a water-cooled copper casing.

3. The system as recited in claim 2, wherein said copper casing is hollow and configured for circular water flow, comprising at least one inlet and at least one outlet connected to a water pump and chiller.

4. The system as recited in claim 1, wherein said Halbach cylinder is configured to produce a uniform external magnetic field between 0.3 T and 0.5 T with a magnetic field gradient parallel to a print table that is smaller than 0.0005 T/mm.

5. The system as recited in claim 1, wherein said Halbach cylinder is arranged such that said external magnetic field is oriented transverse to a print direction of said print head.

6. The system as recited in claim 1, wherein said Halbach cylinder is arranged such that said external magnetic field is oriented longitudinal to a print direction of said print head.

7. The system as recited in claim 1, wherein said Halbach cylinder is a Halbach cylinder providing a horizontal magnetic field to a nozzle of said print head.

8. The system as recited in claim 1, wherein said polymer matrix comprises a thermoplastic selected from the group consisting of Polyetheretherketone (PEEK) and Nylon 4.6.

9. The system as recited in claim 1, wherein said magnetic fillers comprise strontium ferrite powder.

10. The system as recited claim 1 further comprising:
a modular Halbach holder and a holder bracket configured to secure said magnetic field source to a plurality of different desktop 3D printer gantry systems.

11. The system as recited in claim 1, wherein a second Halbach cylinder is inserted in said first Halbach cylinder, wherein said first and second Halbach cylinders are rotated independently with respect to a printer.

12. A method for fabricating an anisotropic bonded magnet using high-temperature magnetic field-assisted additive manufacturing (MFAAM), the method comprising:
feeding a composite filament into a 3D printer, wherein said composite filament comprises a polymer matrix and magnetic fillers;
extruding said composite filament through a heated nozzle while applying a uniform external magnetic field via a Halbach cylinder to align said magnetic fillers in a specific direction; and
actively cooling said Halbach cylinder using a fluid-filled casing to prevent heat transfer from said heated nozzle from reducing magnetic flux of said Halbach cylinder, wherein said aligned magnetic fillers are locked within said polymer matrix upon cooling to form a 3D-printed bonded magnet having a predetermined magnetic anisotropy.

13. The method as recited in claim 12, wherein said polymer matrix is selected from the group consisting of Nylon 6, Nylon 66, Nylon 11, Nylon 12, ABS, PEEK, and Nylon 4.6.

14. The method as recited in claim 12, wherein applying said external magnetic field induces a magnetic S-value of at least 0.92 in a direction normal to a print bed of said 3D printer.

15. The method as recited in claim 12, wherein said Halbach cylinder provides a magnetic field having a field gradient of less than 0.0005 T/mm within a central bore of a magnetic field source assembly.

16. The method as recited in claim 12, wherein said fluid-filled casing is a copper casing and said active cooling comprises circulating water through said copper casing via a chiller system.

17. The method as recited in claim 12 further comprising:
customizing a magnetic strength of said bonded magnet by varying a weight percentage of said magnetic fillers between 10 wt. % and 54 wt. %.

18. The method as recited in claim 12, wherein said Halbach cylinder is rotated along its cylindrical axis by a stepmotor that is controlled through a G-code of said 3D printer.

19. A modular magnetic alignment attachment for an additive manufacturing gantry system, comprising:
a Halbach cylinder configured to generate a magnetic field of at least 0.3 T at a print location;
a hollow copper casing enclosing said Halbach cylinder, wherein said copper casing has fluid ports for connection to an external cooling system; and
a mounting bracket configured for universal attachment to a 3D printer print head assembly.

20. The modular magnetic alignment attachment as recited in claim 19, wherein said Halbach cylinder comprises Neodymium-Iron-Boron (NdFeB) magnets.

21. The modular magnetic alignment attachment as recited in claim 19, wherein said Halbach cylinder comprises Samarium-Cobalt (SmCo) magnets.

22. The modular magnetic alignment attachment as recited in claim 19, wherein said copper casing is configured to prevent said Halbach cylinder from exceeding a service temperature of 70° C. during polymer extrusion.
